(19) United States
(12) Patent Application Publication
(10) Pub. No.: US 2012/0086779 A1
(43) Pub. Date: Apr. 12, 2012

(54) IMAGE PROCESSING APPARATUS, IMAGE PROCESSING METHOD, AND PROGRAM

(76) Inventors: Takafumi MORIFUJI, Tokyo (JP); Masami Ogata, Kanagawa (JP)

(21) Appl. No.: 13/249,965

(22) Filed: Sep. 30, 2011

(30) Foreign Application Priority Data
Oct. 7, 2010 (JP) P2010-227502

(51) Int. Cl. H04N 13/02

(52) U.S. Cl. 348/46; 348/E13.074

(57) ABSTRACT

An image processing apparatus is provided with a parallax detector configured to detect parallax between a left-eye image and a right-eye image used to display a 3D image, a parallax range computing unit configured to compute a range of parallax between the left-eye image and the right-eye image, a determining unit configured to determine whether or not the sense of depth when viewing the 3D image exceeds a preset range that is comfortable for a viewer, on the basis of the computed range of parallax, and a code generator configured to generate a code corresponding to the determination result of the determining unit.

### BACKGROUND

The present technology relates to an image processing apparatus, an image processing method, and a program, and more particularly to an image processing apparatus, an image processing method, and a program configured to be able to easily shoot a 3D image with a sense of depth appropriately set.

Images of 3D content (hereinafter called 3D images) are made up of a left-eye image viewed by the left eye and a right-eye image viewed by the right eye, and a viewer perceives the images as three-dimensional (perceives a sense of depth) due to parallax set between the left-eye image and the right-eye image. Such right-eye images and left-eye images are obtained by being separately imaged with cameras (imaging units) separated by a given spacing (see Japanese Unexamined Patent Application Publication No. 2005-229290, for example).

### SUMMARY

When shooting, the depth (parallax) of a 3D image that is imaged by operating two cameras should be checked in order to check the sense of depth when a viewer views a 3D image, for example, and thus it is difficult to shoot while checking the sense of depth at the time of shooting.

Also, the sense of depth in a 3D image is additionally dependent on the conditions at the time of viewing, such as the display size of the display that displays the 3D image. Consequently, a 3D image should be checked by furnishing a display at the shooting location similar to one used at the time of viewing, for example, and thus it is difficult to shoot a 3D image while recreating the conditions at the time of viewing at the shooting location.

The present technology, being devised in light of such conditions, is configured to be able to easily shoot a 3D image with a sense of depth appropriately set.

An image processing apparatus in accordance with an embodiment of the present technology is provided with a parallax detector configured to detect parallax between a left-eye image and a right-eye image used to display a 3D image, a parallax range computing unit configured to compute a range of parallax between the left-eye image and the right-eye image, a determining unit configured to determine whether or not the sense of depth when viewing the 3D image exceeds a preset range that is comfortable for a viewer, on the basis of the computed range of parallax, and a code generator configured to generate a code corresponding to the determination result of the determining unit.

An image processing method in accordance with an embodiment of the present technology includes detecting parallax between a left-eye image and a right-eye image used to display a 3D image, computing a range of parallax between the left-eye image and the right-eye image, determining whether or not the sense of depth when viewing the 3D image exceeds a preset range that is comfortable for a viewer, on the basis of the computed range of parallax, and generating a code corresponding to that determination result.

A program in accordance with an embodiment of the present technology causes a computer to function as a parallax detector configured to detect parallax between a left-eye image and a right-eye image used to display a 3D image, a parallax range computing unit configured to compute a range of parallax between the left-eye image and the right-eye image, a determining unit configured to determine whether or not the sense of depth when viewing the 3D image exceeds a preset range that is comfortable for a viewer, on the basis of the computed range of parallax, and a code generator configured to generate a code corresponding to the determination result of the determining unit.

In an embodiment of the present technology, parallax between a left-eye image and a right-eye image used to display a 3D image is detected, a range of parallax between the left-eye image and the right-eye image is computed, and on the basis of the computed range of parallax, it is determined whether or not the sense of depth when viewing the 3D image exceeds a preset range that is comfortable for a viewer, and a code corresponding to that determination result is generated.

The image processing apparatus may be an independent apparatus, or may be an internal block constituting a single apparatus.

According to an embodiment of the present technology, a 3D image can be easily shot with a sense of depth appropriately set.

### BRIEF DESCRIPTION OF THE DRAWINGS

FIG. 1 is a block diagram illustrating an exemplary configuration of an embodiment of an imaging apparatus to which the present technology has been applied;

FIG. 2 is a diagram that explains a method for computing a parallax or depth range that is comfortable for a viewer;

FIG. 3 is a block diagram illustrating a exemplary detailed configuration of a parallax information analyzer;

FIG. 4 is a flowchart explaining a shot image display process conducted by an imaging apparatus;

FIG. 5 is a flowchart explaining a shot image recording process conducted by an imaging apparatus;

FIG. 6 is a block diagram illustrating an exemplary configuration of a playback apparatus to which the present technology has been applied;

FIG. 7 is a flowchart explaining a 3D image playback process conducted by a playback apparatus;

FIG. 8 is a block diagram illustrating an exemplary configuration of an embodiment of a computer to which the present technology has been applied.

### DETAILED DESCRIPTION OF EMBODIMENTS

### Exemplary Configuration of Imaging Apparatus

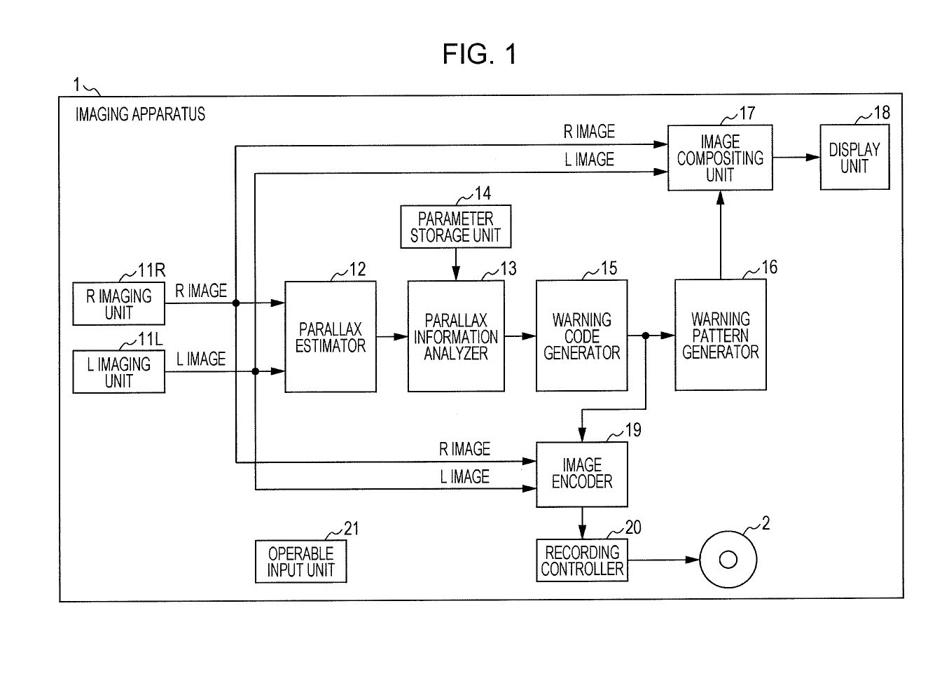

FIG. 1 illustrates an exemplary configuration of an embodiment of an imaging apparatus to which the present technology has been applied.

The imaging apparatus 1 in FIG. 1 images (shoots) a 3D image made up of a left-eye image and a right-eye image, and causes that data (hereinafter also called 3D image data) to be recorded to a recording medium 2 such as a BD-ROM (Blu-Ray® Disc-Read-Only Memory).

The imaging apparatus 1 includes components such as an R imaging unit 11R that images right-eye images, an L imaging unit 11L that images left-eye images, a display unit 18 that displays imaged 3D images, and a recording controller 20 that controls the recording of 3D image data to the recording medium 2.

The R imaging unit 11R images a right-eye image and supplies the right-eye image data obtained as a result to a parallax estimator 12. The L imaging unit 11L images a left-eye image and supplies the left-eye image data obtained as a result to the parallax estimator 12. The R imaging unit 11R and the L imaging unit 11L are provided at positions separated by a given spacing in the same direction as the horizontal direction of the 3D image. Herein, although the R imaging unit 11R and the L imaging unit 11L are integrated into the imaging apparatus 1 in FIG. 1, the R imaging unit 11R and the L imaging unit 11L may also be configured separately from the subsequent blocks that process 3D image data. Also, the R imaging unit 11R and the L imaging unit 11L themselves may be configured separately from each other. Hereinafter, and where appropriate, the R imaging unit 11R and the L imaging unit 11L will be referred to as the imaging unit 11 without distinguishing between them.

The parallax estimator 12 estimates parallax in a 3D image obtained by imaging with the imaging unit 11 (hereinafter also simply called the shot image). More specifically, the parallax estimator 12 detects parallax between a left-eye image and a right-eye image for each of given units that take one pixel or a plurality of pixels as a unit. The parallax estimator 12 generates a parallax map expressing the detected parallax in pixel units, and supplies the parallax map to the parallax information analyzer 13 as parallax information.

The parallax information analyzer 13 uses shooting parameters and display parameters supplied from a parameter storage unit 14 to analyze parallax information supplied from the parallax estimator 12, and estimates the sense of depth when a viewer views a 3D image imaged by the imaging unit 11. With the parallax information analyzer 13, the sense of depth when a viewer views a 3D image is expressed as a range of parallax in the 3D image, or as a range of depth, which is the distance from the position of the imaging unit 11 to the position where a stereoscopic image is produced.

Then, the parallax information analyzer 13 determines whether or not the range of parallax in the 3D image or the range of depth exceeds a comfortable range for a viewer, and supplies the determination results to a warning code generator 15. More specifically, the parallax information analyzer 13 makes a comparison against a range of parallax that is comfortable for a viewer (hereinafter also called the comfortable parallax range), and determines whether the case of the maximum value for the parallax in the 3D image being large, the case of the minimum value being small, or the case of the maximum value being large and the minimum value being small (the case of the range being large) applies. The range of depth is determined similarly.

The parameter storage unit 14 stores shooting parameters and display parameters used by the parallax information analyzer 13 to estimate the sense of depth. The shooting parameters and display parameters stored in the parameter storage unit 14 may be stored in advance as fixed values, or input by the photographer (the user of the imaging apparatus 1) from an operable input unit 21 discussed later. For example, the dot pitch and number of pixels in the horizontal direction (horizontal pixel count) of the image sensor in the imaging unit 11 may be stored in the parameter storage unit 14 in advance as a unique shooting parameter for the imaging apparatus 1. As another example, the dot pitch and horizontal pixel count of a display used when a viewer views a 3D image is input by the user from the operable input unit 21 and stored in the parameter storage unit 14.

The warning code generator 15 generates a warning code on the basis of parallax information analysis results (comparison results) given by the parallax information analyzer 13, and supplies it to a warning pattern generator 16 and an image encoder 19. More specifically, the warning code generator 15 generates a corresponding warning code in the case of being supplied with a determination result indicating that the maximum value is large, the minimum value is small, or the range is large with respect to comfortable parallax and depth ranges.

Herein, in the present embodiment, a code is not made to be specifically generated in the case where the estimated sense of depth is within a comfortable range, but it may also be configured such that a code expressing that the estimated sense of depth is within a comfortable range is supplied to the warning pattern generator 16 and the image encoder 19.

The warning pattern generator 16 generates a given predetermined warning message corresponding to a warning code supplied from the warning code generator 15, and supplies it to an image compositing unit 17. For example, in the case where the range is large with respect to a comfortable parallax range in an imaged 3D image, the warning pattern generator 16 generates the warning message “Parallax exceeds comfortable range”. Also, in the case where the maximum value is large with respect to a comfortable parallax range, the warning pattern generator 16 generates the warning message “Subject is popping out too much”. Alternatively, in the case where the minimum value is small with respect to a comfortable parallax range, the warning pattern generator 16 generates the warning message “Subject is sunken in too much”.

The image compositing unit 17 conducts a control causing the display unit 18 to display a 3D image imaged and obtained by the imaging unit 11. Also, in the case of being supplied with a warning message from the warning pattern generator 16, the image compositing unit 17 composites an OSD (On-Screen Display) image of the warning message onto a 3D image and causes the display unit 18 to display a composite image wherein the warning message is overlaid on top of the 3D image.

The image encoder 19 encodes 3D image data imaged and obtained by the imaging unit 11 with an encoding format such as MPEG-2 (Moving Picture Experts Group phase 2), MPEG-4, or AVC (Advanced Video Coding). Also, in the case of being supplied with a warning code from the warning code generator 15, the image encoder 19 associates and encodes the supplied warning code as additional information for a corresponding 3D image. The 3D image bit stream obtained as a result of encoding is supplied to the recording controller 20.

The recording controller 20 causes a 3D image bit stream supplied from the image encoder 19 to be recorded to a recording medium 2.

The operable input unit 21 includes a shooting start button, a shooting stop button, a zoom switch, etc., and receives operations by the photographer. A signal expressing received operations by the photographer (operational content) is supplied to respective predetermined units depending on the operational content.

With an imaging apparatus 1 configured as above, in the case where an imaged 3D has exceeded a range that is comfortable for a viewer, a corresponding warning message is displayed on the display unit 18 together with the 3D image. The photographer, seeing the warning message displayed on the display unit 18, is then able in subsequent shooting to adjust the shooting parameters such that the parallax falls in a comfortable range or reshoot.

### [Method of Computing Comfortable Parallax and Depth Ranges]

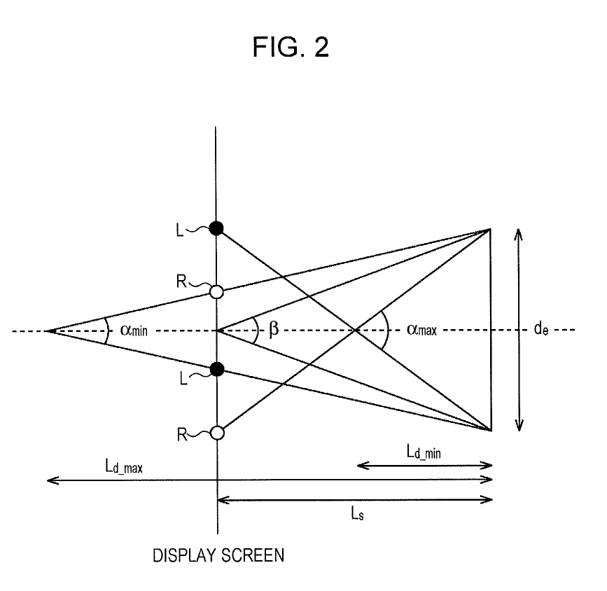

Next, a method of computing a parallax or depth range that is comfortable for a viewer will be explained with reference to FIG. 2.

FIG. 2 is a diagram illustrating the relationship between the parallax on a display that displays a 3D image, and the sense of depth perceived by a corresponding viewer.

Take dₑ to be the interpupillary distance of the viewer, Lₛ to be the viewing distance (the distance from the viewer to the display screen), and L_{d} to be the distance from the viewer to the position where a stereoscopic image is formed. Also, take β to be the angle of convergence in the case where the distance L_{d} to the position where a stereoscopic image is formed is identical to the viewing distance Lₛ, or in other words, the state of no popout or sink-in in a 3D image (the case where the depth of the 3D image is zero). Furthermore, take αₘₐₓ to be the angle of convergence when popout is maximized (parallax is minimized), and take αₘᵢₙ to be the angle of convergence when sink-ink is maximized (parallax is maximized). The distance L_{d} to the position where a stereoscopic image is formed becomes a minimum L_{d}_{_{—}}ₘᵢₙ when the angle of convergence is αₘₐₓ, and becomes a maximum L_{d}_{_{—}}ₘₐₓ when the angle of convergence is αₘᵢₙ.

Typically, it is said that a viewer can view images comfortably if the angle of convergence α for the case where a 3D image has a given depth and the angle of convergence β for the case of zero depth have a parallax angle |α−β| of one degree (1°) or less. Consequently, the relationship between α and β in a range that is comfortable for a viewer is expressed as in the following Eq. 1.

$$\vert α - β \vert \leq 1 ° = \frac{π}{180} \\ α = β \pm \frac{π}{180} \qquad ( 1 )$$

Also, since the relationship between the viewing distance Lₛ and the angle of convergence β for zero depth is

$$\begin{matrix}\frac{\frac{{d}_{e}}{2}}{{L}_{s} } = tan \frac{β}{2} & ( 2 ) \\ β = 2 {tan}^{- 1} \frac{{d}_{e}}{2 {L}_{s}} & ( 3 )\end{matrix}$$

the relationship between the distance L_{d} to the position where a stereoscopic image is formed and the angle of convergence α becomes

$${L}_{d} = \frac{{d}_{e}}{2 tan \frac{α}{2}} \qquad ( 4 )$$

by transforming Eq. 2.

Since the potential range for the angle of convergence α is αₘᵢₙ≦α≦αₘₐₓ, the range for the distance L_{d} to the position where a stereoscopic image is formed becomes

$${L}_{d \_ min} \leq {L}_{d} \leq {L}_{d \_ max} \\ \frac{{d}_{e}}{2 tan \frac{{α}_{max}}{2}} \leq {L}_{d} \leq \frac{{d}_{e}}{2 tan \frac{{α}_{min}}{2}} \\ where \\ {α}_{max} = β + \frac{π}{180} \\ {α}_{min} = β - \frac{π}{180} \qquad ( 5 )$$

can be expressed.

Consequently, the range for the distance L_{d} to the position where a stereoscopic image is formed can be computed if the interpupillary distance dₑ and the angle of convergence β for zero depth are given. Since the angle of convergence β for zero depth can be computed with the interpupillary distance dₑ and the viewing distance Lₛ according to Eq. 3, a range for the distance L_{d} to the position where a stereoscopic image is formed ultimately can be computed if the interpupillary distance dₑ and the viewing distance Lₛ are given. When shooting, the distance L_{d} to the position where a stereoscopic image is formed is equivalent to the depth, the interpupillary distance dₑ is equivalent to the base length of the imaging unit 11, and the viewing distance Lₛ is equivalent to the focal length of the imaging unit 11.

Also, a range for parallax which can be comfortably viewed may also be computed from the geometrical relationships illustrated in FIG. 2 among the angle of convergence αₘₐₓ where popout is maximized, the angle of convergence αₘᵢₙ where sink-in is maximized, the interpupillary distance dₑ, and the depth L_{d}. Furthermore, if the dot pitch and horizontal pixel count of the display used when a viewer views a 3D image are given, a range for parallax which can be comfortably viewed may be expressed by a pixel count.

For example, if the viewing distance Lₛ is taken to be 1.7 m and the interpupillary distance dₑ is taken to be 6.5 cm given a display with a 46″ widescreen display size, then the range of depth L_{d} which can be comfortably viewed becomes from 0.5 m (near) to 1.5 m (far) (0.5 m≦L_{d}≦1.5 m). Also, the range of parallax which can be comfortably viewed becomes from −56 pixels (near) to 55 pixels (far).

### [Exemplary Detailed Configuration of Parallax Information Analyzer 13]

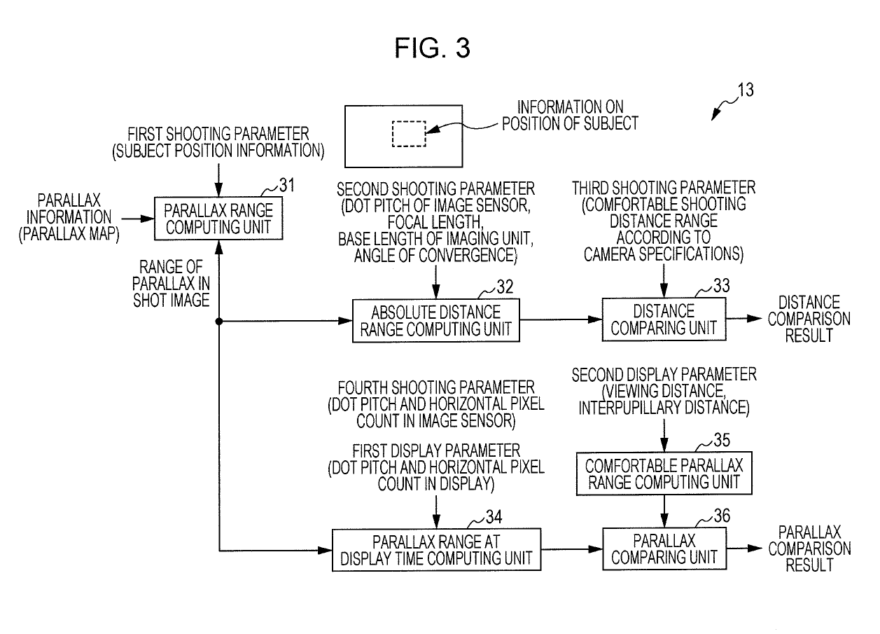

FIG. 3 is a block diagram illustrating an exemplary detailed configuration of a parallax information analyzer 13.

The parallax information analyzer 13 includes a parallax range computing unit 31, an absolute distance range computing unit 32, a distance comparing unit 33, a parallax range at display time computing unit 34, a comfortable parallax range computing unit 35, and a parallax comparing unit 36.

The parallax range computing unit 31 computes a range (maximum value and minimum value) of parallax in a shot 3D image on the basis of parallax information (a parallax map) for a shot 3D image supplied from the parallax estimator 12. The parallax range returned as the computation result is supplied to the absolute distance range computing unit 32 and the parallax range at display time computing unit 34.

Meanwhile, in the case the photographer has set a position for a subject to be shot, subject position information for that set position is supplied from the parameter storage unit 14 to the parallax range computing unit 31 as a first shooting parameter. The parallax range computing unit 31, in the case of being supplied with subject position information, computes a range of parallax in a shot 3D image only for the area set by that subject position information.

The absolute distance range computing unit 32 calculates a range of depth at the time of shooting on the basis of a second shooting parameter supplied from the parameter storage unit 14. The dot pitch and focal length of the imaging unit 11 as well as the base length and angle of convergence of the R imaging unit 11R and the L imaging unit 11L are supplied as the second shooting parameter.

The distance comparing unit 33 is supplied with a range of correct shooting distances given by the camera specifications as a third shooting parameter from the parameter storage unit 14, and with a range of depth at the time of shooting from the absolute distance range computing unit 32. The distance comparing unit 33 compares the range of depth at the time of shooting to the range of correct shooting distances (correct shooting distance range), and supplies the comparison result to the warning code generator 15 (FIG. 1) as a parallax information analysis result.

More specifically, the distance comparing unit 33 outputs that the maximum value is large, the minimum value is small, the range is large, or the depth is within range with respect to the correct shooting distance range, as the comparison result.

Herein, it may also be configured such that in the case where either the maximum value or the minimum value for the depth at the time of shooting exceeds the correct shooting distance range, the distance comparing unit 33 outputs, together with the comparison result, a value computed by the absolute distance range computing unit 32 for that which exceeds the correct shooting distance range.

The parallax range at display time computing unit 34 is supplied with the dot pitch and horizontal pixel count of the image sensor in the imaging unit 11 as a fourth shooting parameter from the parameter storage unit 14, and is also supplied with the dot pitch and horizontal pixel count of the display with which a viewer views a 3D image as a first display parameter.

The parallax range at display time computing unit 34 converts the range of parallax in a shot image into a range of parallax at the time of display, according to the dot pitch of the image sensor and of the display.

The comfortable parallax range computing unit 35 computes a range of parallax that is comfortable for a viewer (comfortable parallax range) on the basis of a viewing distance Lₛ and an interpupillary distance dₑ supplied from the parameter storage unit 14, according to the method described with reference to FIG. 2. The computed comfortable parallax range is supplied to the parallax comparing unit 36.

The parallax comparing unit 36 compares the range of parallax at the time of display supplied from the parallax range at display time computing unit 34 to the comfortable parallax range supplied from the comfortable parallax range computing unit 35, and supplies the comparison result to the warning code generator 15 (FIG. 1) as a parallax information analysis result. More specifically, the parallax comparing unit 36 outputs that the maximum value is large, the minimum value is small, the range is large, or the parallax is within range with respect to the correct shooting distance range, as the comparison result.

Herein, it may also be configured such that in the case where either the maximum value or the minimum value for the parallax at the time of display exceeds the comfortable parallax range, the parallax comparing unit 36 outputs, together with the comparison result, a value computed by the parallax range at display time computing unit 34 for that which exceeds the comfortable parallax range.

The first through fourth shooting parameters and first and second display parameters discussed above are stored in the parameter storage unit 14 and are supplied to respective units of the parallax information analyzer 13, but it is also possible to store less than all of the first through fourth shooting parameters and the first and second display parameters. In other words, some of the first through fourth shooting parameters and the first and second display parameters may be omitted or substituted with given values.

If a position for a subject to be shot is not particularly specified, then a range of parallax will be computed for the entirety of a shot image, and thus the first shooting parameter supplied to the parallax range computing unit 31 may be omitted.

As discussed above, a range determination (comparison) according to depth and a range determination (comparison) according to parallax may be conducted in the parallax information analyzer 13, but since the amount of popout in a 3D image is determined by the parallax, the process of range determination according to depth may also be omitted. In this case, the second shooting parameter and the third shooting parameter may be omitted. For the photographer, however, depth is more intuitive and easily understood than parallax. Consequently, a range determination (comparison) according to depth has the advantage of enabling a warning message that is intuitive and easily understood by the photographer to be displayed. This can be even more intuitive and easily understood if specific numbers for that which exceeds a comfortable range are also displayed at this point.

The fourth shooting parameter and the first and second display parameters are for conducting a range determination (comparison) according to parallax. However, in the case where the imaging unit 11 is integrated into the imaging apparatus 1, the fourth shooting parameter giving the dot pitch and horizontal pixel count of the image sensor may be stored in advance in the parameter storage unit 14 as established, fixed values.

Also, three times the height of the display (3H) is typically adopted as the viewing distance Lₛ and 6.5 cm is typically adopted for the interpupillary distance dₑ of the second display parameter. Consequently, by estimating the display size from the first display parameter, calculating three times its height, and taking 6.5 cm as the default for the interpupillary distance dₑ, user input of the viewing distance Lₛ and the interpupillary distance dₑ of the second display parameter can be omitted.

### [Shot Image Display Process]

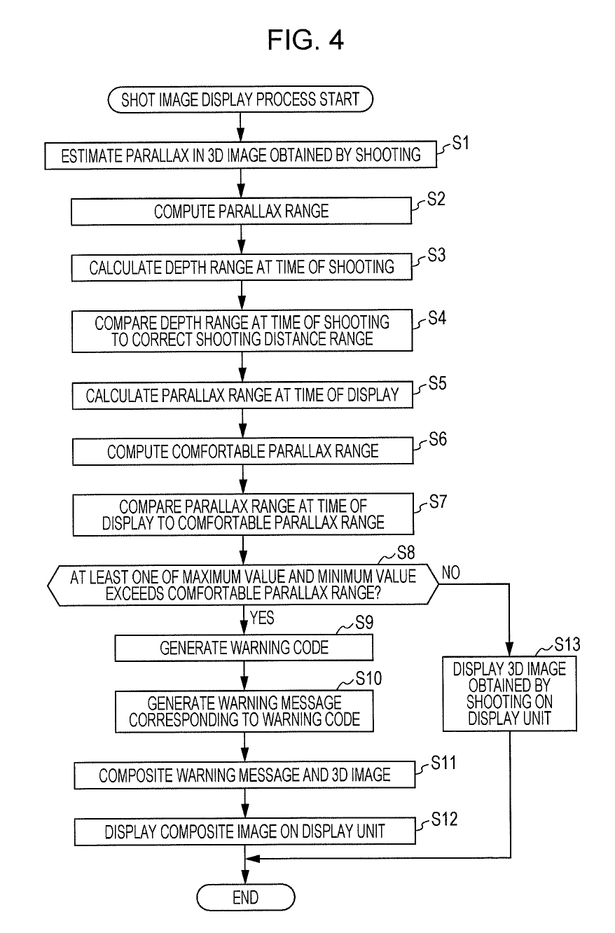

A shot image display process that displays a shot image shot by the imaging apparatus 1 on the display unit 18 will now be explained with reference to the flowchart in FIG. 4. This process is initiated when a 3D image is output from the imaging unit 11.

First, in a step S1, the parallax estimator 12 estimates parallax in a 3D image imaged and obtained by the imaging unit 11. More specifically, a parallax map is generated in which the parallax between the right-eye image and the left-eye image imaged and obtained by the R imaging unit 11R and the R imaging unit 11R is detected in units of pixels, for example. The parallax map is supplied to the parallax information analyzer 13 as parallax information.

In a step S2, the parallax range computing unit 31 of the parallax information analyzer 13 computes the parallax range of the 3D image on the basis of the parallax information supplied from the parallax estimator 12. In other words, the parallax range computing unit 31 computes a maximum value and a minimum value for the parallax in the 3D image, and supplies them to the absolute distance range computing unit 32 and to the parallax range at display time computing unit 34.

In a step S3, the absolute distance range computing unit 32 calculates a range of depth at the time of shooting on the basis of a second shooting parameter supplied from the parameter storage unit 14. At this point, the second shooting parameter is the dot pitch and focal length of the image sensor in the imaging unit 11, as well as the base length and angle of convergence of the R imaging unit 11R and the L imaging unit 11L.

In a step S4, the distance comparing unit 33 compares the calculated range of depth at the time of shooting to a range of correct shooting distances (correct shooting distance range) given as the third shooting parameter, and supplies the comparison result to the warning code generator 15 as a parallax information analysis result.

In a step S5, the parallax range at display time computing unit 34 calculates the parallax range at display time by converting the range of parallax in the shot image into a range of parallax at the time of display according to the dot pitch ratio between the image sensor and the display.

In a step S6, the comfortable parallax range computing unit 35 computes a range of parallax that is comfortable for a viewer (comfortable parallax range) on the basis of a viewing distance Lₛ and an interpupillary distance dₑ supplied from the parameter storage unit 14, according to the method described with reference to FIG. 2. The computed comfortable parallax range is supplied to the parallax comparing unit 36.

In a step S7, the parallax comparing unit 36 compares the range of parallax at the time of display supplied from the parallax range at display time computing unit 34 to the comfortable parallax range supplied from the comfortable parallax range computing unit 35, and supplies the comparison result to the warning code generator 15 as a parallax information analysis result.

The comfortable parallax range may be pre-calculated before a 3D image is shot, and in this case, the processing in step S6 may be omitted. Also, the processing in steps S3 and S4, and the processing in steps S5 and S7, may be executed in parallel or in reverse order.

In a step S8, the warning code generator 15 determines whether or not to generate a warning code, on the basis of parallax information analysis results (comparison results) given by the parallax information analyzer 13. In other words, the warning code generator 15 determines if at least one of the maximum value and the minimum value of the depth at the time of shooting exceeds the correct shooting distance range, and also if at least one of the maximum value and the minimum value of the parallax at the time of display exceeds the comfortable parallax range.

The process proceeds to a step S9 in the case where, in step S8, at least one of the maximum value and the minimum value of the depth at the time of shooting exceeds the correct shooting distance range, or at least one of the maximum value and the minimum value of the parallax at the time of display exceeds the comfortable parallax range. In step S9, the warning code generator 15 generates a warning code based on the parallax information analysis results, and supplies it to the warning pattern generator 16 and the image encoder 19.

In a step S10, the warning pattern generator 16 generates a given warning message determined according to the warning code supplied from the warning code generator 15, and supplies it to the image compositing unit 17.

For example, a warning message such as “Zoom out” or “Decrease the camera spacing” may be generated with respect to a warning code indicating that the range of depth at the time of shooting exceeds the correct shooting distance range. Also, a warning message such as “Zoom out or move away from subject”, “Reduce the angle of convergence”, or “Decrease the camera spacing” may be generated in the case where the maximum value of the depth at the time of shooting exceeds the correct shooting distance range. A warning message such as “Zoom out or move closer to subject”, “Increase the angle of convergence”, or “Decrease the camera spacing” may be generated in the case where the minimum value of the depth at the time of shooting exceeds the correct shooting distance range.

For a warning message such as “Zoom out”, it may also be configured such that an optimum warning message is made to be generated while taking into account settings information (shooting information) such as the current zoom level, the camera spacing, and the angle of convergence, as well as their configurable ranges. For example, in the case where the current zoom setting value is at the wide limit, the zoom level is not lowered any further, and thus the warning pattern generator 16 may be configured to generate the warning message “Move away from subject” rather than “Zoom out”.

Meanwhile, a warning message such as “Parallax exceeds comfortable range” is generated with respect to a warning code indicating that the parallax at the time of display exceeds the comfortable parallax range. Also, a warning message such as “Subject is popping out too much” is generated with respect to a warning code indicating that the maximum value of the parallax at the time of display exceeds the comfortable parallax range. A warning message such as “Subject is sunken in too much” is generated with respect to a warning code indicating that the minimum value of the parallax at the time of display exceeds the comfortable parallax range.

The warning pattern generator 16 displays a corresponding warning message in the case where either a warning code related to the depth at the time of shooting or a warning code related to the parallax at the time of display is supplied. In the case where both a warning code related to the depth at the time of shooting and a warning code related to the parallax at the time of display are supplied, the warning pattern generator 16 displays a warning message corresponding to a predetermined one of the warning codes. It may also be configured such that the photographer is able to set which warning code to prioritize from the operable input unit 21.

In a step S11, the image compositing unit 17 generates a composite image in which (an OSD image of) a warning message supplied from the warning pattern generator 16 is composited with a 3D image supplied from the imaging unit 11.

In a step S12, the image compositing unit 17 causes the display unit 18 to display the composite image, and ends the process.

In contrast, the process proceeds to a step S13 in the case where it is determined in step S8 that the depth at the time of shooting is within the correct shooting distance range, and in addition, the parallax at the time of display is within the comfortable parallax range. In step S13, the image compositing unit 17 causes the display unit 18 to display a 3D image imaged and obtained by the imaging unit 11 as-is, and ends the process.

As above, in an imaging apparatus 1, parallax information is analyzed for a 3D image that has been imaged and obtained, and the display unit 18 can be made to display warning messages such as “Parallax exceeds comfortable range” in real-time while shooting. In so doing, the photographer is able to easily shoot a 3D image with a sense of depth appropriately set.

### [Shot Image Recording Process]

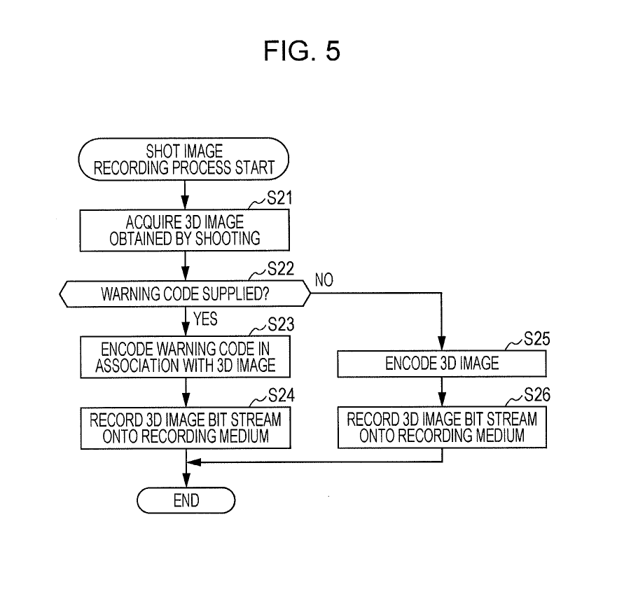

FIG. 5 illustrates a flowchart for a shot image recording process that records a shot image to a recording medium 2. This process is initiated when a 3D image is output from the imaging unit 11, and is executed in parallel with the shot image display process of FIG. 4 discussed above.

In a step S21, the image encoder 19 acquires a 3D image that has been imaged and obtained by the imaging unit 11.

In a step S22, the image encoder 19 determines if a warning code has been supplied from the warning code generator 15.

In the case where it is determined in step S22 that a warning code has been supplied, the process proceeds to a step S23, and the image encoder 19 associates the warning code as additional information for a corresponding 3D image. Then, the image encoder 19 encodes the 3D image data, including the additional information, with a given encoding format such as MPEG-2, MPEG-4, or AVC.

In a step S24, the recording controller 20 causes the 3D image bit stream obtained as a result of encoding to be recorded to the recording medium 2, and ends the process.

In contrast, in the case where it is determined in step S22 that a warning code has not been supplied, the process proceeds to a step S25, and the image encoder 19 encodes the acquired 3D image with a given encoding format.

Then, in a step S26, the recording controller 20 causes the 3D image bit stream obtained as a result of encoding to be recorded to the recording medium 2, and ends the process.

As above, in an imaging apparatus 1, a warning code based on a parallax information analysis result for a 3D image that has been obtained by imaging can be recorded to a recording medium 2 together with the 3D image. In so doing, a suitable warning message can be displayed on the basis of a warning code in the case of playing back a 3D image recorded to the recording medium 2.

### [Exemplary Configuration of Playback Apparatus]

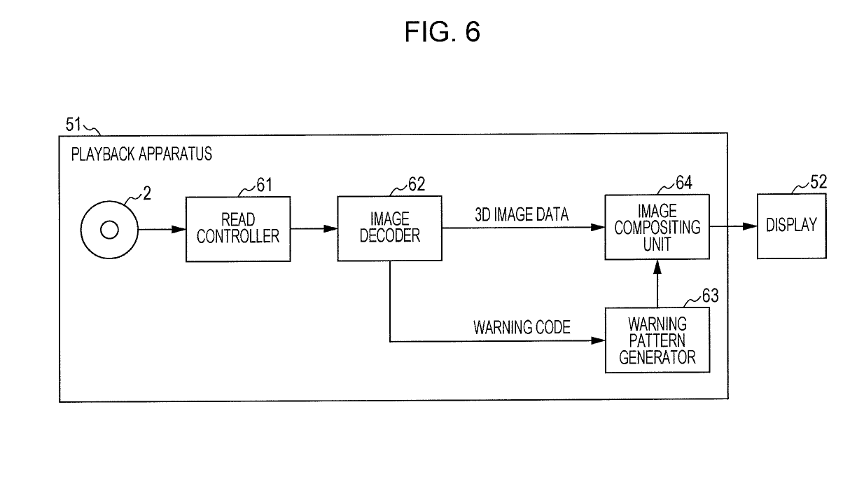

FIG. 6 is a block diagram illustrating an exemplary configuration of a playback apparatus that plays back a 3D image recorded to the recording medium 2.

The playback apparatus 51 in FIG. 6 plays back a 3D image recorded to the recording medium 2 and causes it to be displayed on the display 52 of a television receiver, etc.

The playback apparatus 51 at least includes a read controller 61, an image decoder 62, a warning pattern generator 63, and an image compositing unit 64.

The read controller 61 reads out a 3D image bit stream recorded to the recording medium 2, and supplies it to the image decoder 62.

The image decoder 62 decodes a 3D image bit stream supplied from the read controller 61 in a format corresponding to the encoding format of the image encoder 19 in FIG. 1. The 3D image data obtained as a result of decoding is supplied to the image compositing unit 64. In the case where a warning code is included in the 3D image bit stream as additional information, the image decoder 62 supplies the warning code to the warning pattern generator 63.

The warning pattern generator 63 generates a given, predetermined warning message in accordance with a warning code, and supplies it to the image compositing unit 64. The warning pattern generator 63 generates a warning message such as “This image contains heavy popout” or “Watch from a suitable distance away from the display” with respect to a warning code, for example.

The image compositing unit 64 conducts a control causing the display 52 to display a 3D image on the basis of 3D image data supplied from the image decoder 62. Also, in the case of being supplied with a warning message from the warning pattern generator 63, the image compositing unit 64 composites an OSD image of the warning message onto a 3D image and causes the display 52 to display a composite image wherein the warning message is overlaid on top of the 3D image.

[3D Image Playback Process]

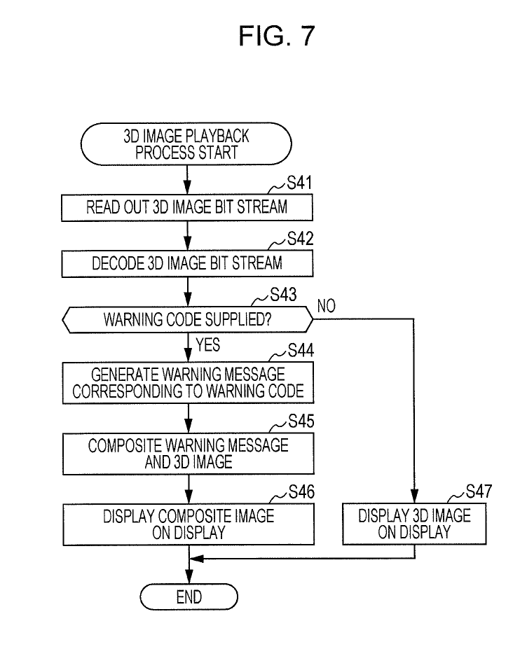

A 3D image playback process conducted by the playback apparatus 51 will now be explained with reference to the flowchart in FIG. 7. This process is initiated when instructions are issued for playback of a recording medium 2 loaded into the playback apparatus 51, for example.

First, in a step S41, the read controller 61 reads out a 3D image bit stream recorded to a recording medium 2, and supplies it to the image decoder 62.

In a step S42, the image decoder 62 decodes the 3D image bit stream supplied from the read controller 61 in a format corresponding to the encoding format of the image encoder 19 in FIG. 1. The 3D image data obtained as a result of decoding is supplied to the image compositing unit 64, and a warning code included as additional information is supplied to the warning pattern generator 63.

In a step S43, the warning pattern generator 63 determines if a warning code has been supplied from the image decoder 62.

In the case where it is determined in step S43 that a warning code has been supplied, the process proceeds to a step S44. The warning pattern generator 63 generates a given, predetermined warning message in accordance with the warning code, and supplies it to the image compositing unit 64.

Then, in a step S45, the image compositing unit 64 composites the warning message from the warning pattern generator 63 with the 3D image from the image decoder 62, and in a step S46, causes the display 52 to display the composite image, and ends the process.

In contrast, in the case where it is determined in step S43 that a warning code has not been supplied, the process proceeds to a step S47. The image compositing unit 64 causes the display 52 to display a 3D image on the basis of the 3D image data supplied from the image decoder 62, and ends the process.

As above, according to a 3D image playback process of a playback apparatus 51, a warning message based on parallax information for a 3D image can be displayed overlaid on top of the 3D image on the basis of a warning code included in a 3D image bit stream recorded to a recording medium 2.

Herein, in the example discussed above, a warning code was recorded to the recording medium 2 as additional information such that a warning message would be displayed overlaid on top of a corresponding 3D image. However, a warning code may also be recorded to the recording medium 2 such that a warning message such as “An image with heavy popout will be displayed” is displayed on a 3D image that precedes the 3D image exceeding the comfortable parallax range by a given amount of time. In this case, a warning message can be displayed before a 3D image with heavy popout is actually displayed, and a viewer can prepare or take action for viewing.

In the example discussed above, an example where image data and a warning code for a 3D image are supplied from a photographer's imaging apparatus 1 to a viewer's playback apparatus 51 via a recording medium 2 was described. However, a 3D image bit stream that includes image data and a warning code for a 3D image may also be supplied to a viewer's playback apparatus by satellite broadcasting, cable TV, or transmission via a network such as the Internet.

The series of processes discussed above may be executed in hardware, and may also be executed in software. In the case of executing the series of processes in software, a program constituting such software may be installed to a computer. Herein, a computer includes computers built into special-purpose hardware, and computers able to execute various functions by installed various programs thereon, such as a general-purpose personal computer, for example.

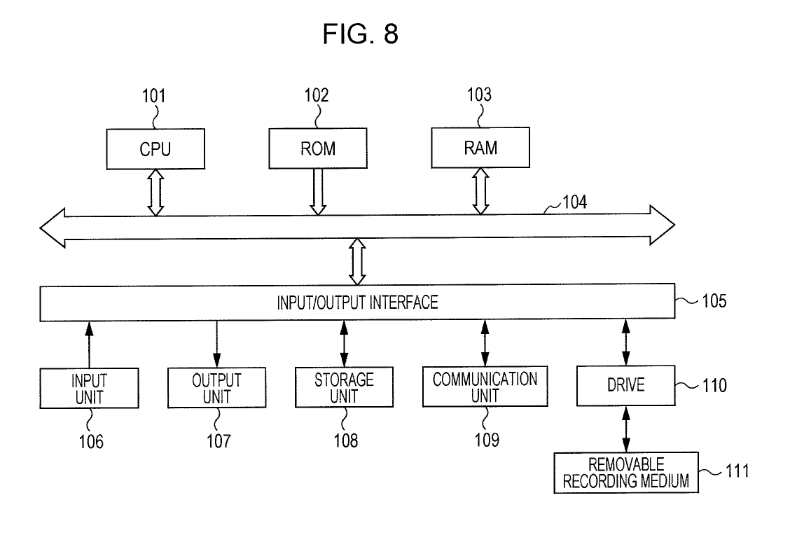

FIG. 8 is a block diagram illustrating an exemplary hardware configuration of a computer that executes the series of processes discussed above according to a program.

In the computer, a CPU (Central Processing Unit) 101, ROM (Read-Only Memory) 102, and RAM (Random Access Memory) 103 are connected to each other by a bus 104.

An input/output interface 105 is additionally connected to the bus 104. Connected to the input/output interface 105 are an input unit 106, an output unit 107, a storage unit 108, a communication unit 109, and a drive 110.

The input unit 106 includes a keyboard, mouse, microphone, etc. The output unit 107 includes a display, speakers, etc. The storage unit 108 includes a hard disk or non-volatile memory, etc. The communication unit 109 includes a network interface, etc. The drive 110 drives a removable recording medium 111 such as a magnetic disk, an optical disc, a magneto-optical disc, or semiconductor memory.

In a computer configured as above, the series of processes discussed earlier are conducted as a result of the CPU 101 loading a program stored in the storage unit 108 into the RAM 103 via the input/output interface 105 and the bus 104, and then executing the program, for example.

The program executed by the computer (CPU 101) may be provided by being recorded to a removable medium 111 given as packaged media, etc. Also, the program may be provided via a wired or wireless transmission medium such as a local area network, the Internet, or digital satellite broadcasting.

On the computer, the program may be installed to the storage unit 108 via the input/output interface 105 by loading the removable medium 111 into the drive 110. Also, the program may be received by the communication unit 109 via the wired or wireless transmission medium and installed to the storage unit 108. Otherwise, the program may be installed in advance to the ROM 102 or the storage unit 108.

Furthermore, the program executed by the computer may be a program whereby processes are conducted in a time series following the order described in this specification, and may also be a program whereby processes are conducted in parallel or at appropriate timings, such as when called.

An embodiment of the present technology is not limited to the embodiments discussed above, and various modifications are possible within a scope that does not depart from the principal matter of the present technology.

The present disclosure contains subject matter related to that disclosed in Japanese Priority Patent Application JP 2010-227502 filed in the Japan Patent Office on Oct. 7, 2010, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An image processing apparatus, comprising:
a parallax detector configured to detect parallax between a left-eye image and a right-eye image used to display a 3D image;
a parallax range computing unit configured to compute a range of parallax between the left-eye image and the right-eye image;
a determining unit configured to determine whether or not the sense of depth when viewing the 3D image exceeds a preset range that is comfortable for a viewer, on the basis of the computed range of parallax; and
a code generator configured to generate a code corresponding to the determination result of the determining unit.

2. The image processing apparatus according to claim 1, further comprising:
a pattern generator configured to generate a message corresponding to the generated code; and
an image compositing unit configured to composite the message and the 3D image, and cause a given display unit to display the result.

3. The image processing apparatus according to claim 1, further comprising:
a stream generator configured to generate a 3D image bit stream from 3D image data of the left-eye image and the right-eye image, with the code generated by code generator added as additional information; and
a recording controller configured to record the 3D image bit stream to a given recording medium.

4. The image processing apparatus according to claim 1, wherein the determining unit includes
a parallax range at display time computing unit configured to convert the computed range of parallax into a range of parallax at the time of display according to the dot pitch ratio between an image sensor and a display,
a comfortable parallax range computing unit configured to compute a range of parallax that is comfortable for a viewer on the basis of a viewer's viewing distance and interpupillary distance, and
a parallax comparing unit configured to compare the range of parallax at the time of display to the range of parallax that is comfortable for a viewer, and wherein
the determining unit determines whether or not the sense of depth when viewing the 3D image exceeds a preset range that is comfortable for a viewer, according to the comparison result of the parallax comparing unit.

5. The image processing apparatus according to claim 1, wherein the determining unit includes
an absolute distance range computing unit configured to calculate a range of depth at the time of shooting, and
a distance comparing unit configured to compare the computed range of depth at the time of shooting to a range of correct shooting distances given by the specifications of the imaging apparatus that imaged the left-eye image and the right-eye image, and wherein
the determining unit determines whether or not the sense of depth when viewing the 3D image exceeds a preset range that is comfortable for a viewer, according to the comparison result of the distance comparing unit.

6. An image processing method, including:
detecting parallax between a left-eye image and a right-eye image used to display a 3D image;
computing a range of parallax between the left-eye image and the right-eye image; and
determining whether or not the sense of depth when viewing the 3D image exceeds a preset range that is comfortable for a viewer, on the basis of the computed range of parallax, and generating a code corresponding to that determination result.

7. A program causing a computer to function as:
a parallax detector configured to detect parallax between a left-eye image and a right-eye image used to display a 3D image;
a parallax range computing unit configured to compute a range of parallax between the left-eye image and the right-eye image;
a determining unit configured to determine whether or not the sense of depth when viewing the 3D image exceeds a preset range that is comfortable for a viewer, on the basis of the computed range of parallax; and
a code generator configured to generate a code corresponding to the determination result of the determining unit.
